(19) United States
(12) Patent Application Publication
(10) Pub. No.: US 2013/0216378 A1
(43) Pub. Date: Aug. 22, 2013

(54) Passive Governor for Windpower Applications

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/397,962

(22) Filed: Feb. 16, 2012

(51) Int. Cl. F03D 7/04; F03D 11/00; F03D 1/06

(52) U.S. Cl. 416/1; 416/10

(57) ABSTRACT

A wind turbine with a passive pitch control system is disclosed. The wind turbine comprises a tower with a nacelle mounted to the tower. A hub is rotatably mounted to the nacelle. The hub has a plurality of blades extending therefrom with each blade rotatable around a longitudinal axis of each blade. A pitch control system is operatively associated with each blade. The pitch control system controls the pitch of each blade around the blade's longitudinal axis. In a preferred embodiment, the pitch control system comprises a flyweight governor and a preloaded spring biased against each other.

### TECHNICAL FIELD

The present disclosure relates generally to wind turbines and, more particularly, to an improved design for a passive pitch control system which includes a flyweight governor.

### BACKGROUND

In recent years, wind turbines have been integrated into electric power generation systems to create electricity to support the needs of both industrial and residential applications. These wind turbines capture the kinetic energy of the wind and convert it into electricity. A typical wind turbine includes a set of two or three large blades mounted to a hub. Together, the blades and hub are referred to as the rotor. The rotor is connected to a main shaft, which in turn, is connected to a generator. When the wind causes the rotor to rotate, the kinetic energy of the wind is captured and converted into rotational energy. The rotational energy of the rotor is translated along the main shaft to the generator, which then converts the rotational energy into electricity.

Nearly all wind turbines utilize pitch control systems to control how the turbine blades interact with the wind. The pitch control system rotates each blade around the longitudinal axis of the blade in order to effectively capture wind or not capture wind to avoid damage of the turbine at high speed winds. The pitch, or angle, of the blade around the longitudinal axis can greatly affect the generated power output.

When there is a continual flow of wind, the wind turbine can generate significantly more power if the blades are pitched to capture the wind. In order to increase the amount of wind captured by the rotor, the turbine blades can be pitched toward a power position. A power position is a lower pitch angle that aligns the blade to capture wind, or pitches the blade into greater influence of the wind. In particular, the blades are perpendicular to the flow of the wind, which causes the rotor to rotate faster. This in turn increases the torque on the main shaft that is delivered to the electric generator, resulting in increased output power.

At times when there are high speed winds that could cause damage to the wind turbine by overspeeding, it would be ideal for the blades to be pitched to capture less wind energy. In order to decrease the amount of wind captured by the rotor, the blades can be pitched toward a feather position. A feather position is a higher pitch angle where the blade is not aligned to capture wind, or angled away from influence of the wind. In particular, the blades are parallel to the flow of the wind. This in turn decreases the torque on the main shaft that is delivered to the electric generator, resulting in decreased power output.

Pitch control systems can be active or passive. Active pitch control systems utilize hydraulic, pneumatic, or electro-mechanical actuators in concert with a closed loop control system to drive the blades to a specific angle of attack. These systems are both accurate and fast. However, active pitch control systems are rather expensive and can consume a large percentage of the wind turbine's own generated output power. Wind turbine designers have explored several passive pitch control architectures including aerodynamic pitch control, aerodynamic stall blades, passive yaw systems, and flexible blades. However, a need still exists for a simplified, accurate passive pitch control system. This invention is directed to solving this need and provides a way to reduce the cost and complexity of the wind turbine blade pitch control system by utilizing a flyweight governor.

### SUMMARY OF THE INVENTION

According to one embodiment of the present disclosure, a wind turbine is disclosed. The wind turbine may comprise a tower, a nacelle mounted at a top of the tower with the nacelle containing at least one generator, a hub rotatably mounted to the nacelle, a main shaft operatively connected between the hub and the generator, a plurality of blades radially extending from the hub with each blade mounted for rotation around a longitudinal axis of each blade, and a pitch control system adapted to control a pitch of each blade around each longitudinal axis. The pitch control system may comprise a flyweight mechanism and a preloaded spring, the flyweight mechanism and preloaded spring being biased against each other.

According to another embodiment, a windpower generator system is disclosed. The windpower generator system may comprise a rotatable hub, a plurality of blades radially extending from the hub with each blade mounted for rotation around a longitudinal axis of each blade, and a pitch control system operatively associated with each blade to control a pitch of each blade around the longitudinal axis of each blade. The pitch control system may comprise a flyweight mechanism and a preloaded spring, the flyweight mechanism and preloaded spring being biased against each other. The hub, blades, and pitch control system may all be provided as an assembly which is stationary relative to ground.

According to yet another embodiment, a method for generating electricity from wind is disclosed. The method may comprise providing a tower with a nacelle mounted to the tower, a hub being rotatably mounted to the nacelle and including a plurality of blades radially extending therefrom, each blade being rotatable about its longitudinal axis. The method may further comprise using the blades to capture the kinetic energy of wind, converting the kinetic energy of wind into rotational energy with at least one shaft which rotates as the wind forces the plurality of blades and hub to rotate, and using a pitch control system to control the pitch of the blades around the longitudinal axis of each blade. The pitch control system may comprise a flyweight mechanism and a preloaded spring, the flyweight mechanism and preloaded spring being biased against each other.

Other advantages and features will be apparent from the following detailed description when read in conjunction with the attached drawings.

### BRIEF DESCRIPTION OF THE DRAWINGS

FIG. 1 is a perspective view of a wind turbine made according to one embodiment of the present disclosure;

FIG. 2 is a cross-sectional view of the wind turbine of FIG. 1 taken along line 2-2, with the pitch control system and blades in power position;

FIG. 3 is a cross-sectional view of the wind turbine of the present disclosure, with the pitch control system and blades in feather position;

FIG. 4 is a cross-sectional view of a wind turbine made according to another embodiment of the present disclosure, with the pitch control system, mechanical trigger mechanism, and blades set in the initial feather position;

FIG. 5 is a cross-sectional view of the wind turbine of the present disclosure, with the pitch control system, mechanical trigger mechanism, and blades in power position; and

FIG. 6 is a cross-sectional view of the wind turbine of the present disclosure, with the pitch control system, mechanical trigger mechanism, and blades in feather position.

### DETAILED DESCRIPTION

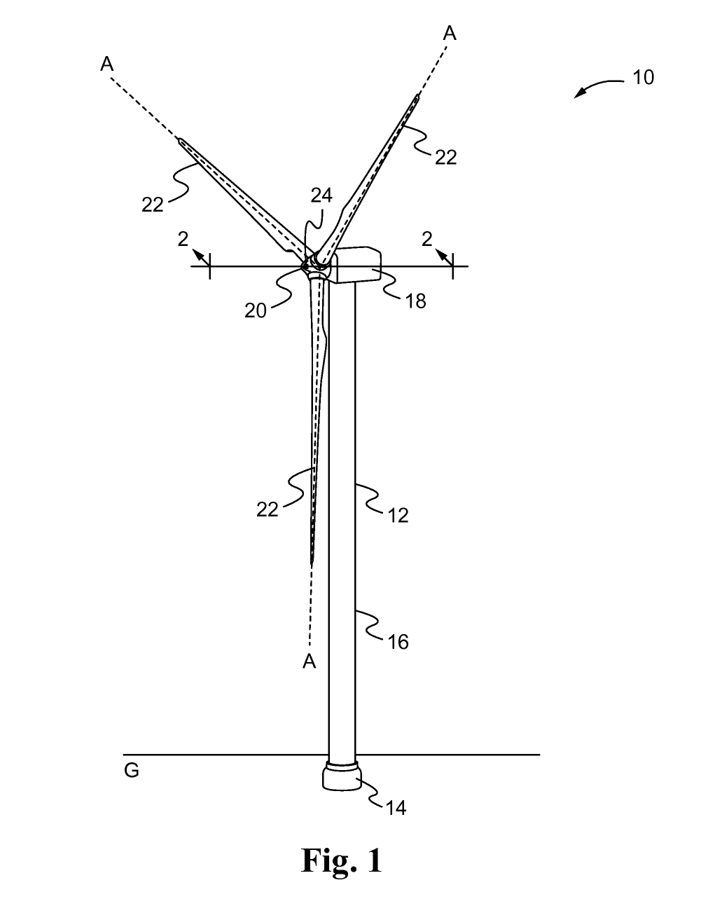

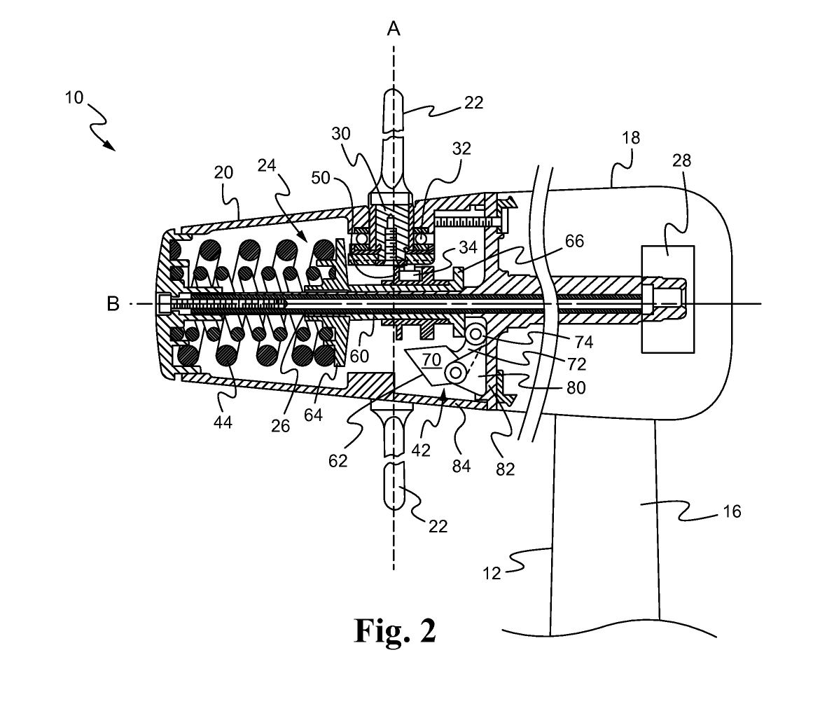

Referring to FIGS. 1 and 2, a wind turbine 10 according to an embodiment of the present disclosure is shown. While all components of the wind turbine are not shown or described, the wind turbine 10 may include a vertically oriented tower 12, which has a stationary base 14 and body element 16. The stationary base 14 of the tower 12 is permanently situated on the ground G and therefore, the wind turbine 10 is structurally stable and cannot be moved. The body element 16 is attached to the stationary base 14 and extends upwards to a height at which the wind turbine 10 can optimally capture the kinetic energy of the wind. A nacelle 18 is rotatably mounted on top of the body element 16 of the tower 12. A hub 20 is mounted for rotation to the nacelle 18. The hub 20 is mounted to a main shaft 26, which is operatively connected to the generator 28.

Radially extending from the hub 20 are a plurality of blades 22. Each of the blades 22 is mounted for rotation around a longitudinal axis A of each blade 22. A pitch control system 24 is secured to each blade 22 to control the pitch of each blade 22 around the longitudinal axis A of the blade 22.

According to one embodiment of the present disclosure, the turbine blades 22 can be mounted to the hub 20 through a base section 30 and supported for rotation by thrust bearings 32. The blades 22 are mounted for rotation around the longitudinal axis A. Each blade 22 is secured to the pitch control system 24 through a pin 34. The pitch control system 24 includes a flyweight mechanism 42 and a preloaded spring 44 coiled around the main shaft 26. The flyweight mechanism 42 includes a pin housing member 50, sliding member 60, and a flyweight governor 62. The pin housing member 50 of the flyweight mechanism 42 receives the pin 34 of the blade 22 and is mounted on the sliding member 60. Through the mating engagement of the pin 34 and the pin housing member 50, the pitch control system 24 is secured to the blade 22.

The sliding member 60 of the flyweight mechanism 42 is generally cylindrical in shape and situated around the main shaft 26. Although shown and described as having a cylindrical shape, the sliding member 60 of the flyweight mechanism could have any shape, including but not limited to cubical, spherical, conical, and tubular, without departing from the scope of this disclosure. The sliding member 60 includes a first rigid protrusion 64 at one end and a second rigid protrusion 66 at the other end. The first protrusion 64 of the cylindrical sliding member 60 engages and acts against the preloaded spring 44. The second protrusion 66 of the cylindrical sliding member 60 is in contact with and engages the flyweight governor 62.

As shown in FIG. 2, when there is no wind present, the blades 22 of the wind turbine 10 are set in the power position. The blades 22 optimally capture the wind when pitched in power position. In the power position, the blade 22 is pitched into greater influence of the wind (i.e. perpendicular to the flow of the wind). As the wind flows, the plurality of blades 22 and hub 20 rotate about the main shaft axis B. The hub 20, which is mounted to the main shaft 26, causes the main shaft 26 to also rotate about main shaft axis B. The main shaft 26, which is operatively connected to the generator 28, delivers this rotational energy to the generator 28. The generator 28 subsequently converts the rotational energy into electricity.

As the hub 20 and blades 22 are rotating, the flyweight mechanism 42, being biased against the preloaded spring 44, governs the speed of the wind turbine 10. The flyweight governor 62 has a flyweight 70, lever 72, and roller 74. The flyweight 70 is pivotally mounted to a support structure 80 on the back wall 82 of the hub 20. The roller 74 of the flyweight governor contacts the second rigid protrusion 66 and engages the sliding member 60. The lever 72 extends from the flyweight 70 and is mounted to the roller 74. The lever connects the flyweight 70 to the roller 74. In the figures, only one flyweight 70, lever 72, roller 74, etc. are shown. However, two or more flyweights evenly spaced around the main shaft axis B would not be outside the scope of the invention. In fact, such an arrangement may allow for proper balance.

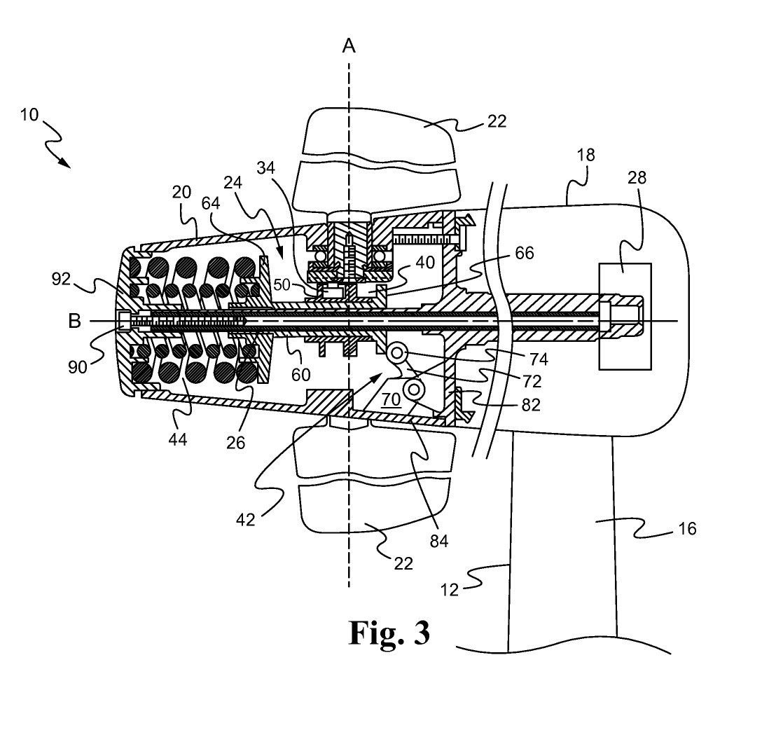

As the windflow increases, the hub 20 rotates faster, and the centrifugal force within the hub causes the flyweight 70 to move away from the main shaft axis B and radially outward toward the sidewall 84 of the hub 20, as shown in FIG. 3. Consequently, the roller 74, which is attached to the flyweight 70 by the lever 72 and engaged to the sliding member 60 at second protrusion 66, pushes the sliding member 60 against the preloaded spring 44 and compresses it. In addition, since the pin housing member 50 and engaged pin 34 are mounted on the moving sliding member 60, the blade 22 (which is attached to the pin 34) also moves and changes its pitch angle around the longitudinal axis A. As a result of the varying rotation and centrifugal force within the hub, the flyweight mechanism 42 and preloaded spring 44 act against each other to passively control the blade pitch and establish rotational equilibrium based on the windflow and the load applied to the wind turbine 10.

In the case of high wind events, when the rotation of the hub 20 has reached its maximum limit, the blades 22 are pitched in the feather position, as shown in FIG. 3. In the feather position, the turbine blades are pitched to capture less wind. Feather position is the position in which the blades are angled away from the influence of the wind (i.e. parallel to the flow of the wind). More specifically, the flyweight 70 is forced against the sidewall 84 of the hub 20. The roller 74 simultaneously pushes the sliding member 60 toward the preloaded spring 44, and the attached pin housing member 50 and pin 34 move the blade 22 around longitudinal axis A so that it is parallel to the windflow. In this way, no damage is caused to the wind turbine because it is not subject to overspeeding. Unlike wind turbines that utilize brakes, the pitch control system 24 of the present disclosure sheds the load caused by high-speed winds when the blades are pitched in feather position, thereby eliminating drag, overheating, and damage to the blades, generator, bearings, gears, and other components of the wind turbine system.

When the wind slows down and reciprocally the rotation of the hub 20 decreases, the centrifugal force within the hub decreases. As a result of the decreased centrifugal force pushing the flyweight 70 against the sidewall 84 of the hub 20, the preloaded spring 44 is able to decompress and, in turn, push the sliding member 60 toward the back wall 82 of the hub 20. As the sliding member 60 is pushed back, the roller 74 is also pushed toward the back wall 82 and the flyweight 70 moves radially inward toward the main shaft axis B and away from the sidewall 84 of the hub 20. Therefore, when there is little to no wind, the blade 22 will be in power position and ready to capture wind again, as shown in FIG. 2.

In addition, a maximum speed of the wind turbine can be predetermined by setting the load of the preloaded spring 44. More specifically, a speed control fastener 90 can secure the nose cone 92 of the hub 20 to the end of the main shaft 26, preferably by threaded engagement. The nose cone 92 and speed control fastener 90 can be rotatably adjusted on the hub about the main shaft axis B. The preloaded spring 44 is compressed between the nose cone 92 and the first protrusion 64 of the sliding member 60. Thus, the load on the spring 44 is determined by the amount of compression caused by the adjustable nose cone 92 and speed control fastener 90 against the spring 44. The amount of compression on the preloaded spring 44 governs the overall speed of the wind turbine 10 by determining the resistance biased against the flyweight mechanism 42. The higher the preloaded spring 44 is initially compressed, the more flyweight mechanism 42 force will be required to overcome the preloaded spring 44. The higher flyweight mechanism 42 force will be generated by higher rotational speeds. Therefore, as the preloaded spring 44 is set to a higher state of pre-load, the wind turbine will settle at a higher operating speed. Similarly, less initial pre-load on the preloaded spring 44 will result in a lower speed of the wind turbine. Although a nose cone 92 and speed control fastener 90 are shown and described herein, it will be understood that other methods of creating the initial spring pre-load including, for example, but not limited to, shims, threaded screws, different spring rate springs, pneumatic springs, trapping air in a bladder to push against the flyweight mechanism, and magnetic springs, may all be used for altering the turbine operating speed without departing from the scope of this disclosure.

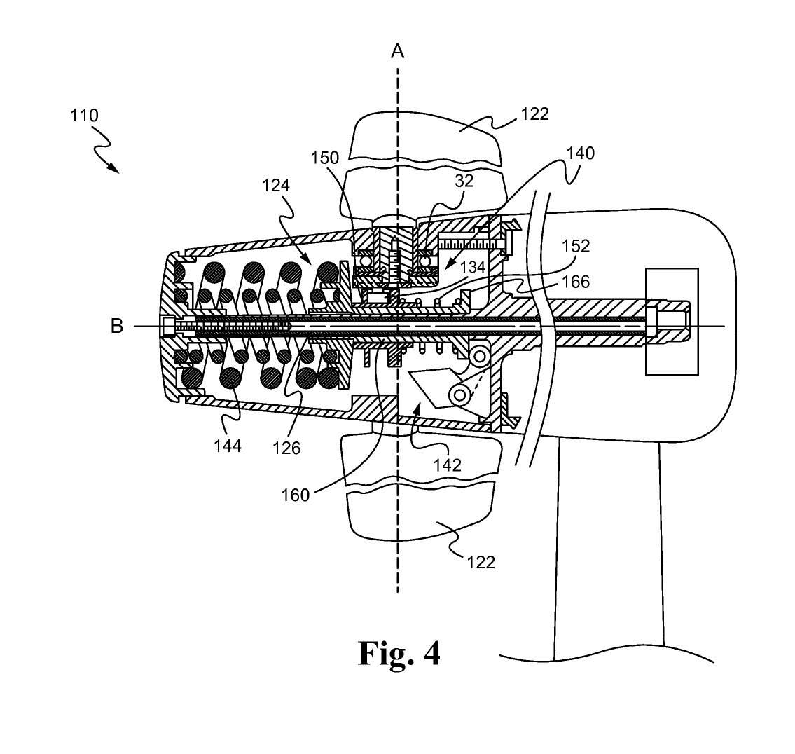

According to another embodiment of the present disclosure shown in FIGS. 4-6, the pitch control system 124 may also include a mechanical trigger mechanism 140 in addition to the flyweight mechanism 142, and the preloaded spring 144 coiled around the main shaft 126. When there is no wind present for which the wind turbine 110 to capture, the blades 122 are initially set in the feather position, as shown in FIG. 4. The mechanical trigger mechanism 140 includes a pin housing member 150 and a second spring 152. The pin housing member 150 of the trigger mechanism 140 receives the pin 134 of the blade 122. Through the mating engagement of the pin 134 and the pin housing member 150, the pitch control system 124 is secured to the blade 122. The second spring 152 of the trigger mechanism 140 is coiled around the main shaft 126 and sliding member 160. Specifically, the second spring 152 is compressed between the pin housing member 150 and the second rigid protrusion 166 of the sliding member 160. In this way, the second spring 152 is biased against the pin housing member 150. Thus, when there is no wind to move the blades 122, the second spring 152 acts against the pin housing member 150 and pin 134 to keep the blade 122 in feather position.

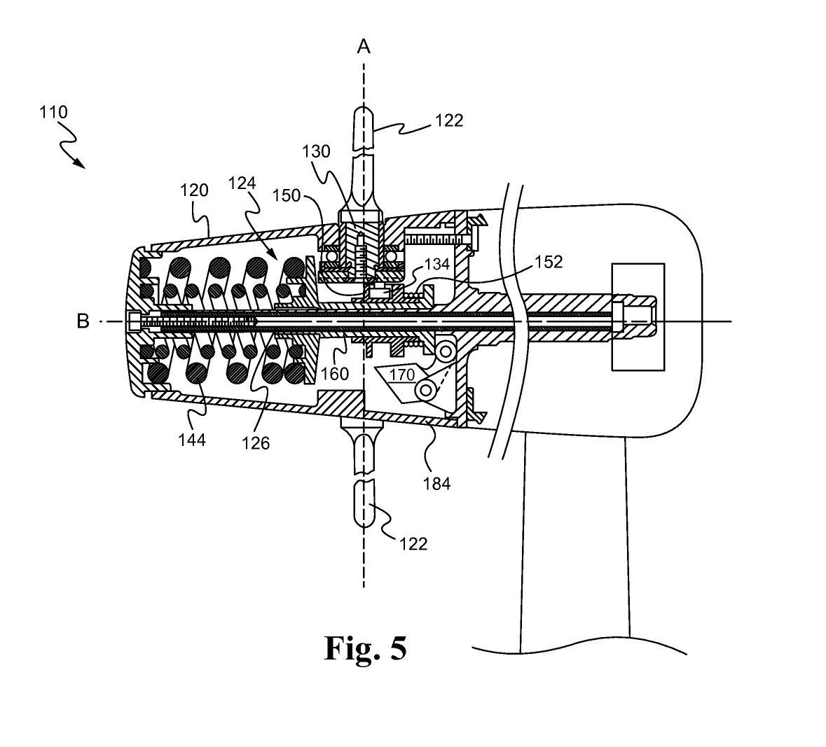

When enough wind flows by the wind turbine 110 to induce a high starting torque, the blades 122 are moved to power position, as shown in FIG. 5. More specifically, the force of the wind causes each blade 122 to centrifugally twist around the longitudinal axis A. This torque, or centrifugal twisting motion, of the blade is transferred through to the base section 130, connected pin 134, and associated pin housing member 150. The pin housing member 150 is moved against and compresses the second spring 152. Thus, the blade 122 is pitched into greater influence of the wind (i.e. perpendicular to the flow of the wind), or power position.

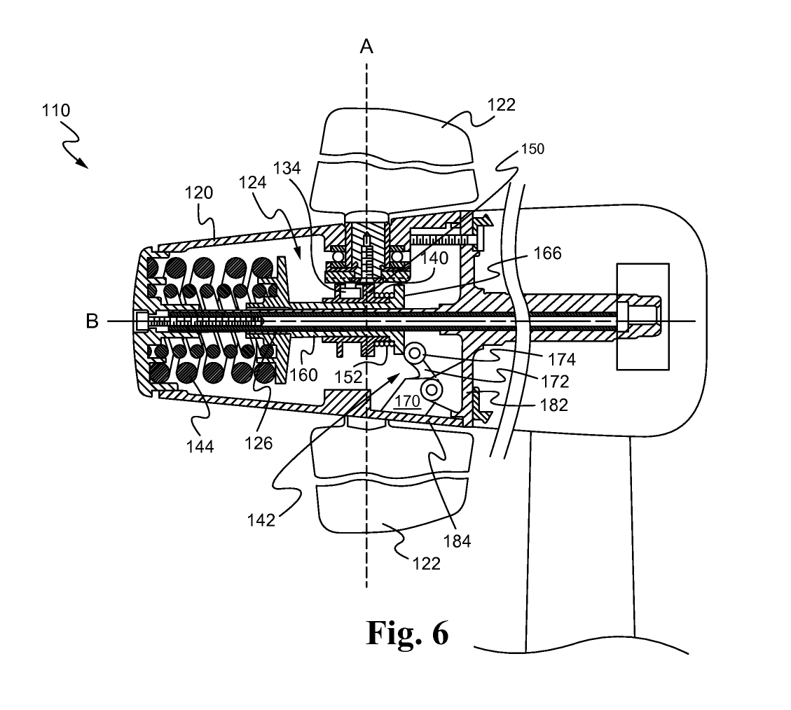

As the windflow increases, the hub 120 rotates faster, and the centrifugal force within the hub causes the flyweight1 170 to move away from the main shaft axis B and radially outward toward the sidewall 184 of the hub 120, as shown in FIG. 6. Consequently, the roller 174, which is attached to the flyweight 170 by the lever 172 and engaged to the sliding member 160 at second protrusion 166, pushes the sliding member 160 against the preloaded spring 144 and compresses it. In addition, since the pin housing member 150 and engaged pin 134 are mounted on the moving sliding member 160, the blade 122 (which is attached to the pin 134) also moves and changes its pitch angle around longitudinal axis A. As a result of the varying rotation and centrifugal force within the hub 120, the flyweight mechanism 142 and preloaded spring 144 act against each other to passively control the blade pitch and establish rotational equilibrium based on the windflow.

In the case of high wind events, when the rotation of the hub 120 has reached its maximum limit, the blades 122 are pitched in the feather position, as shown in FIG. 6. When the wind slows down and reciprocally the rotation of the hub 120 decreases, the centrifugal force within the hub decreases. As a result of the decreased centrifugal force pushing the flyweight 170 against the sidewall 184 of the hub 120, the preloaded spring 144 is able to decompress and, in turn, push the sliding member 160 toward the back wall 182 of the hub 120. As the sliding member 160 is pushed back, the roller 174 is also pushed toward the back wall 182 and the flyweight 170 moves radially inward toward the main shaft axis B and away from the sidewall 184 of the hub 120. At the same time, the second spring 152 of the trigger mechanism 140 decompresses as the second protrusion 166 of the sliding member 160 moves towards the back wall 182 of the hub 120. Therefore, when there is no wind, the blade 122 will be set in the initial feather position and ready to capture wind again, as shown in FIG. 4.

From the foregoing detailed description, it is apparent that the disclosure described is an inexpensive, simple, efficient, and reliable form of passive pitch control utilized to control the rotational speed of the wind turbine. While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. A wind turbine comprising:
a tower;
a nacelle mounted at a top of the tower, the nacelle containing at least one generator;
a hub rotatably mounted to the nacelle;
a main shaft operatively connected between the hub and the generator;
a plurality of blades radially extending from the hub, each blade mounted for rotation around a longitudinal axis of each blade; and
a pitch control system adapted to control a pitch of each blade around each longitudinal axis, the pitch control system comprising:
a flyweight mechanism; and
a preloaded spring, the flyweight mechanism and preloaded spring being biased against each other.

2. The wind turbine of claim 1, wherein the preloaded spring is coiled around the main shaft.

3. The wind turbine of claim 2, wherein the flyweight mechanism comprises:
a sliding member situated about the main shaft and directly opposing the preloaded spring; and
a flyweight governor member engaged with the sliding member.

4. The wind turbine of claim 3, wherein the pitch control system further comprises a mechanical trigger mechanism for initially rotating each blade to fine pitch.

5. The wind turbine of claim 4, wherein the trigger mechanism is mounted on the sliding member of the flyweight mechanism.

6. The wind turbine of claim 5, wherein the pitch control system is secured to each blade by a pin, the pin mounted on the trigger mechanism of the pitch control system.

7. The wind turbine of claim 6, wherein the trigger mechanism comprises:
a pin housing member for receiving the pin on the trigger mechanism; and
a second spring directly opposing the pin housing member.

8. The wind turbine of claim 3, wherein the sliding member is cylindrical in shape about the main shaft.

9. The wind turbine of claim 8, wherein the sliding member has a first rigid projection member at one end to engage the preloaded spring and a second rigid projection member at the other end to engage the flyweight governor member.

10. The wind turbine of claim 9, wherein the hub further comprises:
a nose cone; and
a speed control fastener secured to the nose cone and engaged to one end of the main shaft, wherein the nose cone and speed control fastener are adjustable.

11. The wind turbine of claim 10, wherein the preloaded spring is compressed between the nose cone and the sliding member of the flyweight mechanism thereby allowing the adjustment of the nose cone and speed control fastener to determine the preset load of the preloaded spring.

12. The wind turbine of claim 11, wherein a maximum speed of the wind turbine is set by adjusting the nose cone and speed control fastener.

13. The wind turbine of claim 12, wherein the speed control fastener is threadably engaged to one end of the main shaft.

14. A windpower generator system comprising:
a rotatable hub;
a plurality of blades radially extending from the hub, each blade mounted for rotation around a longitudinal axis of each blade; and
a pitch control system operatively associated with each blade to control a pitch of each blade around the longitudinal axis of each blade, the pitch control system comprising:
a flyweight mechanism; and
a preloaded spring, the flyweight mechanism and preloaded spring being biased against each other;
wherein the hub, blades, and pitch control system are all provided as an assembly which is stationary relative to ground.

15. The windpower generator system of claim 14, wherein the flyweight mechanism comprises:
a cylindrically shaped sliding member situated about the main shaft and directly opposing the preloaded spring; and
a flyweight governor member engaged with the sliding member.

16. The windpower generator system of claim 15, wherein the pitch control system further comprises:
a mechanical trigger mechanism mounted on the sliding member for initially rotating each blade to fine pitch; and
a pin mounted on the trigger mechanism to secure each blade to the pitch control system.

17. A method for generating electricity from wind comprising:
providing a tower with a nacelle mounted to the tower, a hub being rotatably mounted to the nacelle and including a plurality of blades radially extending therefrom, each blade being rotatable about its longitudinal axis;
using the blades to capture the kinetic energy of wind;
converting the kinetic energy of wind into rotational energy with at least one shaft which rotates as the wind forces the plurality of blades and hub to rotate; and
using a pitch control system to control the pitch of the blades around the longitudinal axis of each blade, the pitch control system comprising:
a flyweight mechanism; and
a preloaded spring, the flyweight mechanism and preloaded spring being biased against each other.

18. The method of claim 17, further comprising adjusting a speed control fastener to set the desired maximum speed of the wind turbine.

19. The method of claim 17, further comprising rotating the blades to fine pitch in order to optimally capture wind.

20. The method of claim 17, further comprising using the flyweight mechanism and the preloaded spring of the pitch control system to rotate the blades to coarse pitch when the wind forces the hub to rotate at or beyond a maximum speed.
